(19) United States
(12) Patent Application Publication
(10) Pub. No.: US 2010/0170774 A1
(43) Pub. Date: Jul. 8, 2010

(54) SWITCHING POLE FOR A HIGH-VOLTAGE NETWORK

(75) Inventors: Jürgen Einschenk, Panketal (DE); Jochen Ermisch, Radebeul (DE); Bernd Specht, Berlin (DE); Ralf-Reiner Volkmar, Oldenburg i. H. (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/664,547

(22) PCT Filed: May 28, 2008
(86) PCT No.: PCT/EP08/56556

§ 371 Date: Dec. 14, 2009

(30) Foreign Application Priority Data
Jun. 15, 2007 (DE) 10 2007 028 205.4

(51) Int. Cl. H01H 31/02

(52) U.S. Cl. 200/48 R

(57) ABSTRACT

A switching pole for a high-voltage network has a switching unit disposed in a switching pole housing. The switching unit includes a fixed contact and a movable contact. An input connector on a fixed contact side is connected to an output connector on the movable contact side in an electrically conductive manner in the switched-on position of the switching unit. In order to be able to simultaneously connect a current sensor and a voltage sensor to one of the connectors while maintaining breakdown safety, an arrangement of the current and voltage sensors is provided at a circumferential distance from each other on the circumferential wall of the switching pole housing, which prevents partial discharges.

The invention relates to a switching pole for a high-voltage network, of the type specified in the precharacterizing clause of patent claim 1.

A switching pole such as this has already been disclosed, for example, in U.S. Pat. No. 5,729,888, in which the switching device is a vacuum interrupter in the switching pole housing. This vacuum interrupter is fitted in an upper hollow chamber in the switching pole housing, which is arranged vertically in the installed state, with the fixed contact side at the top, and the moving contact side at the bottom. On the fixed contact side, the fixed contact of the vacuum interrupter is conductively connected to an input connecting piece, which runs coaxially with respect to the center longitudinal axis of the switching pole housing and has a threaded piece, which is used for line connection, which projects out of the upper end of the housing. At the lower end, a guide tube projects out of the vacuum interrupter, is coupled to the moving contact of the interrupter and passes through a center opening in a bus ring, which is in the form of a pot, of an output connecting piece which projects out of the housing at the side. The moving contact is connected, with an axial coupling, to an insulated switching rod, which is conductively connected all the time to the output connecting piece in the upper end area. In order to switch the interrupter on and off, the switching rod can be moved upward and downward, for example by means of a cam mechanism, with the contacts of the vacuum interrupter being moved toward one another and away from one another. A current sensor and a voltage sensor are arranged on the switching pole housing, for continuous monitoring of the switching state and of operation. The annular current sensor surrounds the input connecting piece and is thus arranged in the upper end area of the switching pole housing. In contrast, the voltage sensor, which is in the form of a rod, is integrated in the tube wall underneath the outlet connecting piece, which is arranged at the side in the center area of the switching pole housing, with this tube wall limiting the lower length area of the hollow chamber on its circumference.

The invention is therefore based on the object of specifying a switching pole of the type specified in the precharacterizing clause of patent claim 1, having a high breakdown resistance in a combined current sensor and voltage sensor arrangement.

This object is achieved by the features of patent claim 1.

Advantageous refinements of the invention are the subject matter of the dependent claims.

The switching pole for a high-voltage network has a switching pole housing composed of solid insulating material, in which a switching device having a fixed contact and a moving contact is arranged, whose moving contact can be moved between the switched-on position and the switched-off position via the reversible-direction feed of a switching rod, wherein, in the switched-on position, an input connecting piece on the fixed contact side is electrically conductively connected to an output connecting piece on the moving contact side by means of the switching device. The switching pole furthermore has a sensor arrangement, which has a current sensor and a voltage sensor. According to the invention, the current sensor and the voltage sensor are connected to an associated connecting piece on the circumferential wall of the switching pole housing, wherein the current sensor is arranged on the circumferential wall of the switching pole housing in a circumferential separation which prevents partial discharges with respect to the voltage sensor.

The joint arrangement of the current sensor and voltage sensor on one of the connecting pieces, in particular on the output connecting piece, makes it possible, for example, to detect a short circuit in the network area connected to the output connecting piece, when the vacuum interrupter is switched off. In this case, the high-voltage potential of the voltage sensor and the ground potential of the current sensor are physically separated from one another, in particular by the circumferential separation provided between the sensors, thus reliably avoiding inhomogeneous field profiles and areas where the breakdown field strength of the insulating material is locally exceeded, thus reliably avoiding partial discharges. In other words: the current sensors and voltage sensors which are connected at the same time to one of the connecting pieces of the switching pole are separated from one another and are arranged on the circumferential wall so as to ensure that the insulation has a high breakdown strength.

The voltage sensor or current sensor which is additionally associated with the connecting piece may, if required, be the voltage sensor or current sensor laid from the other connecting piece. Alternatively, however, both connecting pieces can also be associated with one voltage sensor or one current sensor, if the current measurement is still also intended to be carried out on the other connecting piece.

The arrangement of the sensors according to the invention means that the potentials which are present on a common connecting piece of the voltage sensor and current sensor are spatially better controlled and reset. The offset in the circumferential direction of the switching pole housing necessarily results not only in the spatial equalization of the sensors but also in optimization of the field of the sensor pair associated with the connecting piece.

If the switching pole is provided only with a voltage sensor and a current sensor, these sensors can preferably be arranged on the circumference of the switching pole housing offset through 180 degrees, or at some other predeterminable angle, which is particularly reliable with regard to the avoidance of partial discharges.

If this circumferential offset of 180 degrees is not possible, the current sensor should be arranged offset through an angle of at least 90° on the circumferential wall of the switching pole housing, with respect to the voltage sensor. This still makes it possible to achieve an arrangement of the sensor pair that is free of partial discharges for the switching poles, in the conditions which are normal in high-voltage networks. This circumferential offset through an angle of 90 degrees can still be maintained when the switching pole also has two voltage sensors, which are arranged diametrically opposite, in addition to the current sensor on its circumferential wall.

Because of its elongated form, the voltage sensor or the two voltage sensors may each be integrated in an associated area of the circumferential wall of the switching pole, for example by being embedded or being encapsulated. The voltage sensors are in this case advantageously fitted such that the insulation wall thickness of the switching pole housing resulting from the design also exists between the sensor and the cavity.

In order to allow this with the wall thickness of the switching pole housing being as small and uniform as possible, the voltage sensors are each integrated in a housing web which runs, raised like a tunnel, along the outer circumference of the housing. The length of the housing web is in this case preferably designed such that a length section of the connected sensor line can also be integrated in the housing web.

If the connecting piece with the sensor pair projects radially from the switching pole, the current sensor can preferably be integrated in a branch tube, which insulates the connecting piece, of the switching pole housing at a distance from the circumferential wall of the switching pole. The associated sensor line of the current sensor may in this case advantageously be integrated in a further raised housing web, which runs from the branch tube to the foot of the switching pole.

In a manner similar to the housing web, the sensor line of the voltage sensor can also be integrated in an annular bead on the switching pole housing, in a circumferential section which is governed by the offset with respect to the current sensor, which annular bead extends between the housing web of the voltage sensor and the branch tube, curving through approximately a quarter of a circle.

The voltage sensor is preferably connected to the high-voltage potential on the moving contact side via a sensor line which is bent approximately at right angles. The sensor line may in this case comprise a braid which is guided in a protective tube bent at an angle of 90 degrees. Alternatively, the sensor line of the voltage sensor may be composed of a correspondingly bent wire conductor or wire clip.

If the wall thickness of the switching pole housing with raised embedding of the sensors and possibly sensor lines is as uniform as possible, this has an advantageous effect on the material consumed for production of the housing. Furthermore, heat can be dissipated with fewer problems when there is a high thermal load on the switching pole.

Further expedient refinements and advantages of the invention will become evident from the following description of one exemplary embodiment and with reference to the figures in the drawings, in which mutually corresponding components are provided with the same reference symbols, and in which:

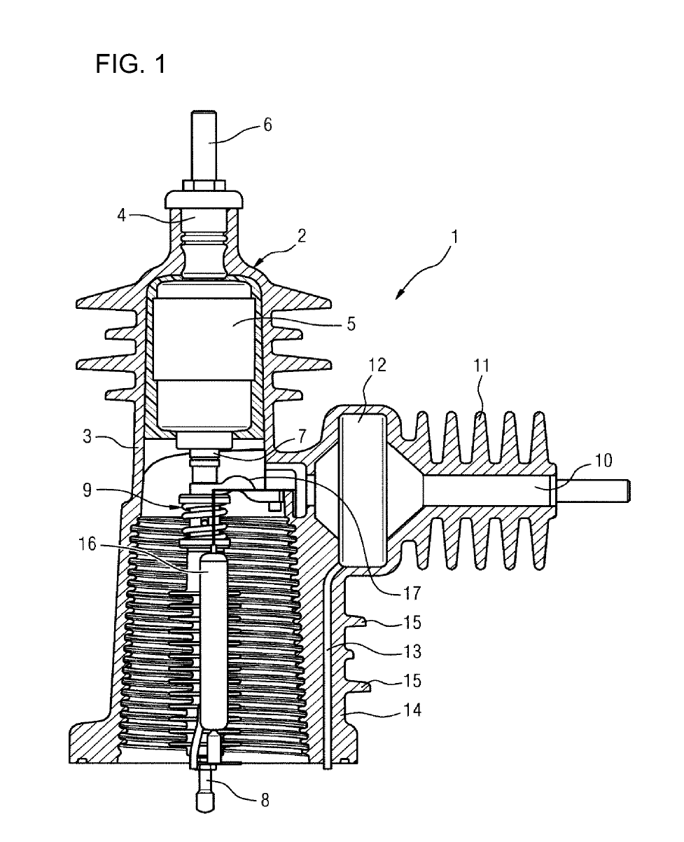

FIG. 1 shows a center longitudinal section through a switching pole which is provided with a sensor arrangement,

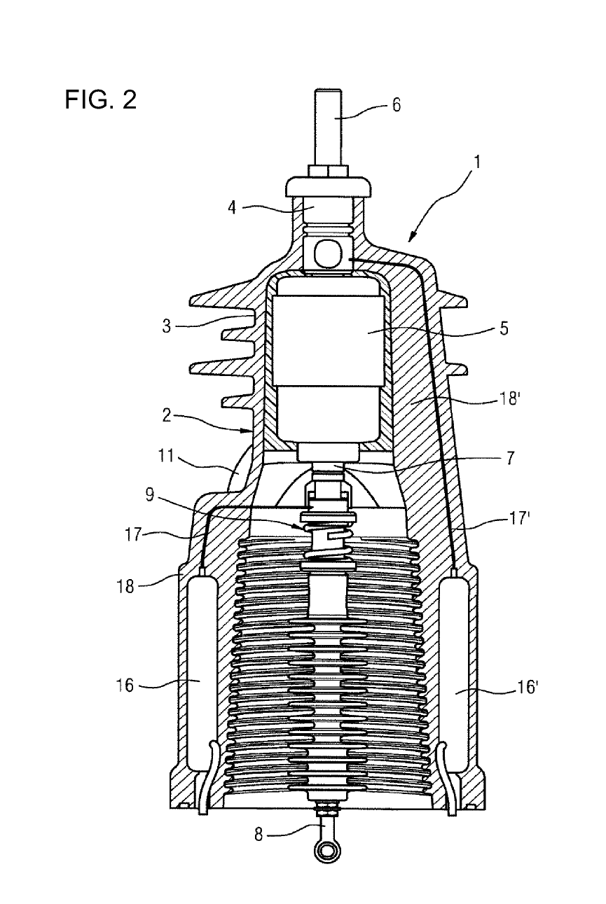

FIG. 2 shows a center longitudinal section through a switching pole having a section profile rotated through 90 degrees with respect to that shown in FIG. 1,

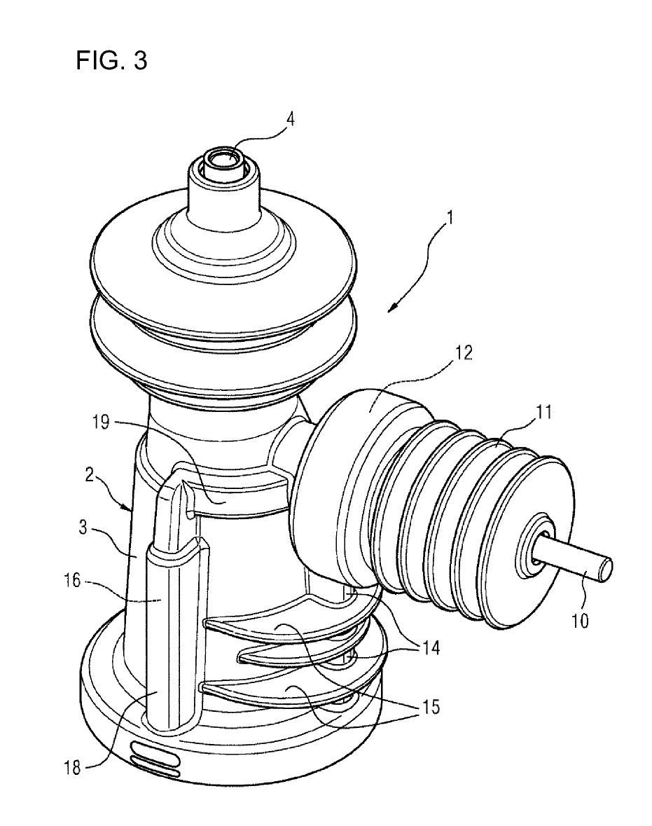

FIG. 3 shows a perspective oblique view from the outside of the switching pole,

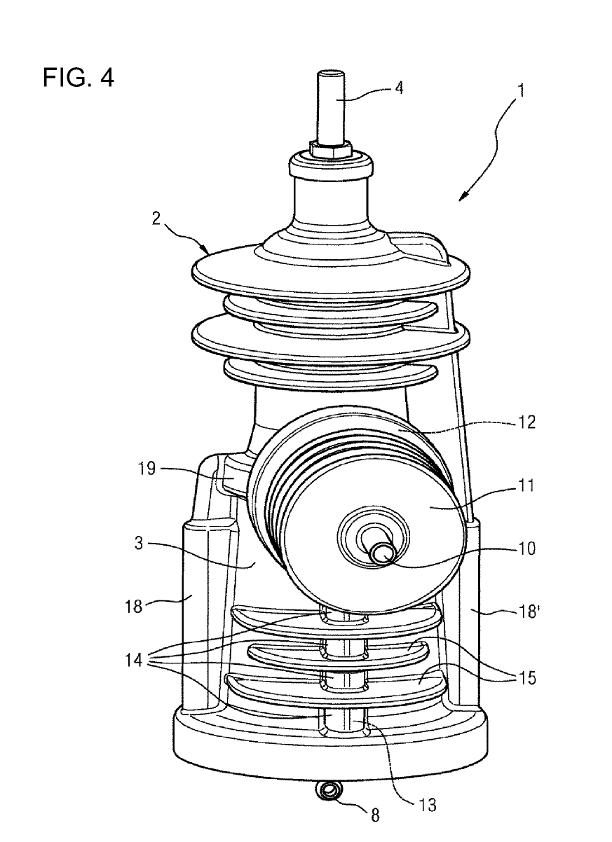

FIG. 4 shows a perspective front view of the output connection side of the switching pole, and

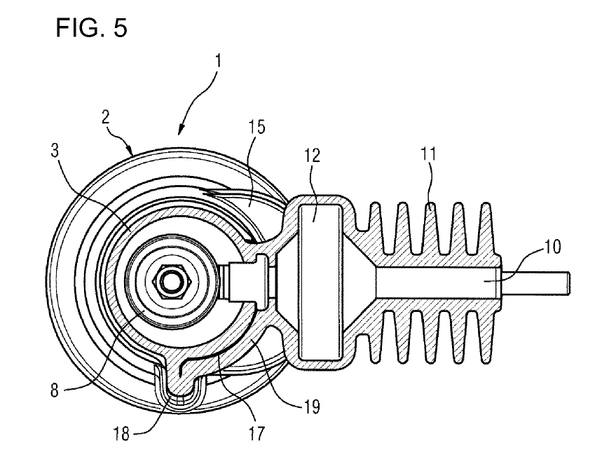

FIG. 5 shows a horizontal section through the switching pole at the level of its side output connecting piece.

Mutually corresponding parts are provided with the same reference symbols in all the figures.

FIG. 1 shows a section through a vertically arranged switching pole 1, which is intended to be used as a switching point in a conventional high-voltage network. The switching pole 1 has a switching pole housing 2 which shields high voltage and is composed of solid insulating material, and, for example, is cast from synthetic resin. This switching pole housing 2 is tubular overall, with the hollow cross section of the circumferential wall 3, which is in the form of a tube wall, being increased in a number of steps from top to bottom. An input connecting piece 4 thus surrounds the circumferential wall 3 in an interlocking manner in the upper area which is tapered to the greatest extent, and this input connecting piece 4 has a threaded pin which projects out of the switching pole housing 2. The electrical line that is fed in can be connected to this connecting piece 4.

Following this, the hollow cross section of the circumferential wall 3 is widened to form a cylindrical hollow chamber, which extends approximately as far as the center of the height of the circumferential wall 3. A vacuum interrupter 5 is fitted such that it cannot move into this hollow chamber, by means of a suitable encapsulation compound, and is arranged coaxially with respect to the center longitudinal axis 6. In the normal manner, the vacuum interrupter 5 has a fixed contact and a moving contact, whose contact surfaces are arranged in a vacuum in the switching chamber of the interrupter 5, although this is not shown. The stationary fixed contact is in this case conductively connected to the input connecting piece 4 all the time, for example via a fixed rod. In contrast, the moving contact is connected to a moving contact rod 7 which projects through a guide tube centrally out of the lower end face of the vacuum interrupter 5. The bushing of the moving contact rod is in this case sealed hermetically, for example by means of a suitable bellows.

In the section located under this, the hollow cross section which is surrounded by the circumferential wall 3 of the switching pole housing 2 widens approximately in the form of a truncated cone. A switching rod 8 projects into the conical hollow cross section essentially along the center longitudinal axis 6 of the switching pole housing 2, and its lower end is articulated on a lifting mechanism, which is not shown, when it is in the installed state. In a central length area, the switching rod 8 is composed of an insulator material while, in the upper end area, it is composed of conductive material. In this case, the upper end of the switching rod 8 is coupled with axial support to the end of the moving contact rod 7, such that the moving contact rod 7 is moved together with the upper end of the switching rod 8. The coupling must in this case be made above a pressure piece 9 which bridges a section, whose length can be varied like a telescope, of the switching rod, by means of a helical compression spring which is supported axially between two ring plates of the switching rod. This allows the switching rod 8 to be provided with an excessive travel, by means of which the contacts are pressed together with a defined force when in the switched-on state, with this force resulting from the spring force of the compressed helical compression spring. This results in advantages in terms of the short-circuit resistance of the vacuum interrupter 5.

In order to allow a current to flow when the vacuum interrupter 5 is switched on, the conductive end area of the switching rod 8 is conductively connected all the time to an output connecting piece 10 for example via a flexible conductor strip, a sliding contact or the like, and the output connecting piece 10 passes through the circumferential wall 3 in the center area and projects from it at the side. In order to insulate the output connecting piece 10, a branch tube 11 is provided, and can advantageously be formed integrally with the circumferential wall 3. An annular current sensor 12 is embedded in the branch tube 11 at a lateral distance from the circumferential wall 3, and allows the current flow in the output connecting part 10 to be detected inductively, in the normal manner. The associated sensor line 13 of the current sensor 12 is in this case encapsulated in a housing web 14 which runs vertically between the center of the branch tube 11 and the foot of the switching pole housing 2. This also results in the radially projecting branch tube 11 being connected with a stiffer angle. One or more reinforcing ribs 15, which run in the circumferential direction of the circumferential wall 3, can be provided in order to increase the bending stiffness of the tunnel-like housing web 14 itself.

In order to additionally allow measurement detection of the voltage which is present on the output connecting part 10, a voltage sensor 16 in the form of a rod is provided and, when seen in a plan view, is arranged offset through an angle of 90 degrees with respect to the current sensor 12 on the circumferential wall 3. The offset arrangement of the voltage sensor 16 and the routing of the associated sensor line are illustrated only in an indicated manner in FIG. 1, because of the section profile.

The arrangement of the voltage sensor 16 on the circumferential wall 3 can be seen more clearly in FIG. 2, since the switching pole housing 2 in FIG. 2 has been sectioned rotated through 90 degree with respect to the center longitudinal axis 6, in comparison to the section profile shown in FIG. 1. As can be seen here, the voltage sensor 16 which is in the form of a rod is embedded or encapsulated completely in a projecting housing web 18 which is raised from the circumferential wall 3 and is correspondingly thicker than the diameter of the voltage sensor 16. In this case, the voltage sensor 16 runs parallel to the center longitudinal axis 6 of the switching pole housing 2. The housing web 18 is lengthened to approximately the height of the center of the switching pole housing 2 above the voltage sensor 16, as a result of which a first length section of the sensor line 17 is embedded in the web extension. At the upper end of this section, the sensor line 17 is first of all bent through approximately 90 degrees and then runs, matched to the circumferential curvature of the circumferential wall 3, in a raised annular bead 19 which extends from the upper end of the web 18 on a lateral plane as far as the branch tube 11, into which it is passed and is connected to the output connecting piece 10. This angled and bent profile of the sensor line 17 therefore corresponds to the profile of the raised external contour of the web 18 and of the annular bead 19 that follows it, and can be seen well in conjunction with the perspective view shown in FIG. 3 and the section illustration shown in FIG. 5. As illustrated, it is in this case advantageous for the length area of the housing web 14 which holds a sensor line section as well as the annular bead 19 adjacent to it to taper, matching the line cross section of the sensor line 17.

A second, structurally identical voltage sensor 16′ is arranged at the same height on the circumferential wall 3 of the switching pole housing 2 diametrically opposite the voltage sensor 16, that is to say offset through 180 degrees in the circumferential direction, likewise extends parallel to the center longitudinal axis 6, and is embedded in an associated housing web 18′. This voltage sensor 18′ is intended to detect the voltage on the input connecting piece 4, for which reason its sensor line 17′ is routed upward along the circumferential wall 3 within the switching pole housing 2. As can be seen in particular in conjunction with FIG. 4, the sensor line 17′ which is bent approximately at right angles only in the upper area, runs obliquely with respect to the center longitudinal axis 6 in a correspondingly lengthened housing web 18, whose cross section tapers appropriately over the height extent of the sensor line 17′.

### LIST OF REFERENCE SYMBOLS

1 Switching pole

2 Switching pole housing

3 Circumferential wall

4 Input connecting piece

5 Vacuum interrupter

6 Center longitudinal axis

7 Moving contact rod

8 Switching rod

9 Pressure piece

10 Output connecting piece

11 Branch tube

12 Current sensor

13 Sensor line

14 Housing web

15 Reinforcing rib

16 Voltage sensor

16′ Voltage sensor

17 Sensor line

17′ Sensor line

18 Housing web

18′ Housing web

19 Annular bead

1-10. (canceled)

11. A switching pole for a high-voltage network, the switching pole comprising:
a switching pole housing composed of solid insulating material and having a circumferential wall;
a switching device having a fixed contact side with a fixed contact and a moving contact side with a moving contact, said switching device disposed in said switching pole housing, said moving contact can be moved between a switched-on position and a switched-off position via a reversible-direction feed of a switching rod;
an output connecting piece disposed on said moving contact side;
an input connecting piece disposed on said fixed contact side, in the switched-on position said input connecting piece is electrically conductively connected to said output connecting piece by means of said switching device; and
a sensor configuration having a current sensor and a voltage sensor, said current sensor and said voltage sensor connected to said output connecting piece on said circumferential wall of said switching pole housing, said current sensor disposed on said circumferential wall of said switching pole housing in a circumferential separation which prevents partial discharges with respect to said voltage sensor.

12. The switching pole according to claim 11, wherein said current sensor is disposed at a predeterminable angle with respect to said voltage sensor.

13. The switching pole according to claim 11, wherein said sensor configuration has two voltage sensors which are arranged at a predeterminable angle being offset with respect to one another through an angle of 180° on said circumferential wall of said switching pole housing.

14. The switching pole according to claim 13, wherein each of said voltage sensors in said sensor configuration is integrated in an associated wall area of said switching pole housing while maintaining a design wall thickness of said circumferential wall.

15. The switching pole according to claim 14, wherein said circumferential wall has a raised housing web and said voltage sensor is integrated in said raised housing web.

16. The switching pole according to claim 15, further comprising a sensor line for said voltage sensor and said raised housing web holds said voltage sensor and a length section, adjacent thereto, of said sensor line.

17. The switching pole according to claim 16, wherein said switching pole housing has a branch tube projecting with a radial extent from said circumferential wall, said branch tube surrounding said output connecting piece in an insulating manner, said current sensor is integrated in said branch tube.

18. The switching pole according to claim 17, wherein:
said switching pole housing has a foot and a further raised housing web disposed between said branch tube and said foot; and
said current sensor has a further sensor line integrated in said further raised housing web.

19. The switching pole according to claim 17, wherein said switching pole housing has an annular bead, said sensor line for said voltage sensor is integrated in said annular bead on said switching pole housing in an offset-dependent circumferential section between said raised housing web and said branch tube.

20. The switching pole according to claim 19, wherein said voltage sensor is connected to said output connecting piece via said sensor line which is bent approximately at right angles and is then curved.

21. The switching pole according to claim 11, wherein said current sensor is disposed offset through an angle of at least 90° on said circumferential wall of said switching pole housing, with respect to said voltage sensor.
